(19) United States
(12) Patent Application Publication
(10) Pub. No.: US 2009/0046328 A1
(43) Pub. Date: Feb. 19, 2009

(54) IMAGE READING APPARATUS AND METHOD OF CORRECTING IMAGE USING THE SAME

(75) Inventor: Byung Jun SUNG, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/111,282

(22) Filed: Apr. 29, 2008

(30) Foreign Application Priority Data
Aug. 17, 2007 (KR) 2007-82730

(51) Int. Cl. H04N 1/04

(52) U.S. Cl. 358/474

(57) ABSTRACT

An image reading apparatus to correct an error in a correction mode desired by a user so as to satisfy a user's desire includes a control unit to correct an error generated in a scanned image of a bound document due to a shape of the bound document, and a display unit to display the image of the document of which the error is corrected. The control unit corrects the error in a correction mode input by the user.

### CROSS-REFERENCE TO RELATED APPLICATIONS

This application claims priority under 35 U.S.C. §119(a) from Korean Patent Application No. 2007-82730, filed on Aug. 17, 2007 in the Korean Intellectual Property Office, the disclosure of which is incorporated herein in its entirety by reference.

### BACKGROUND OF THE INVENTION

1. Field of the Invention

The present general inventive concept relates to an image reading apparatus, and, more particularly, to an image reading apparatus to correct an error of a scanned document and a method of correcting an image using the same.

2. Description of the Related Art

Generally, an image reading apparatus, such as a scanner or a multi-function machine, scans an image to be scanned and outputs a desired image. Such an image reading apparatus may be classified into a sheet-feed scanning type and a flat-bed scanning type.

The sheet-feed scanning type image reading apparatus and the flat-bed scanning type image reading apparatus can automatically and continuously scan several documents by a separate automatic document feeder (ADF).

In the flat-bed scanning type image reading apparatus, a document such as a sheet of paper or a book is fixed and an image sensor is moved, such that the document can be scanned, similar to an operation of a general copier. If a book is scanned using the flat-bed scanning type image reading apparatus, a bound portion of the book to be scanned becomes spaced apart from a reading unit due to a binding state of the book. If a central portion of the book to be read is spaced apart from the reading unit, an amount of light which is reflected from the book to be scanned and is made incident to an image sensor is rapidly reduced.

Accordingly, if the book is scanned using a conventional image reading apparatus, as illustrated in FIG. 1, the central portion A3 of the book to be scanned is not detected by the image sensor and thus a black shadow area A4 appears. Since an image becomes gradually distorted as the image becomes closer to the central portion A3 of the book, a desired image cannot be obtained. Since a portion A5 excluding the book A2 to be scanned is printed with a black color, a consumable product such as ink is wasted.

In order to solve such problems, the conventional image reading apparatus scans a bound document, analyzes the scanned image of the document, detects distortion of the image, and corrects the distortion of the image in a predetermined correction mode according to the detected result.

However, as illustrated in FIG. 2, since the conventional image reading apparatus corrects the distortion of the image in the predetermined correction mode, the correction is not sufficient and correction required by a user is impossible.

Accordingly, satisfying a variety of desires of users is difficult.

### SUMMARY OF THE INVENTION

The present general inventive concept provides an image reading apparatus, which can correct an error in a correction mode desired by a user so as to satisfy a user's desire, and a method of correcting an image using the same.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an image reading apparatus including a control unit to correct an error generated in a scanned image of a bound document due to a shape of the bound document, and a display unit to display the image of the document of which the error is corrected, wherein the control unit corrects the error in a correction mode input by a user.

The foregoing and/or other aspects and utilities of the general inventive concept may also be achieved by providing an image reading apparatus including an input unit to allow a user to input a correction mode in order to correct an error generated in a scanned image of a bound document due to a shape of the bound document, and a control unit to correct the error in the input correction mode.

The image reading apparatus may further include a display unit to display the scanned image of the document.

The control unit may include an analysis unit to analyze the image of the document and detect the error generated due to the shape of the bound document, and a correction unit to correct the detected error in a predetermined correction mode.

The analysis unit may include a size detector to detect a size area of the scanned image of the document, a page detector to detect page areas of the image of the document, a boundary detector to detect a boundary area of the image of the document, a central portion detector to detect a central portion of the image of the document, and a shadow detector to detect a shadow area of a central portion of the image of the document.

The image reading apparatus may further include a memory to store the scanned image of the document, and the display unit may further display a selection message to select the correction mode.

The image reading apparatus may further include an input unit to allow the user to input the correction mode, and the display unit may further output a change message relating to whether the correction mode is changed. The input unit may allow the user to input change selection information.

The correction mode may include an output correction mode to divide the document into pages and output the pages of the document, a straight-line correction mode to correct a curved portion of a central portion of the document to an original state, a removal correction mode to remove a shadow area of the central portion of the document, and a cut correction mode to cut the image of the document.

The foregoing and/or other aspects and utilities of the general inventive concept may also be achieved by providing a method of correcting an image using an image reading apparatus, the method including scanning a bound document, correcting an error generated in an image of the document due to the shape of the bound document, displaying the image of the document on a predetermined screen display device, allowing a user to input a correction mode, and correcting the error in the input correction mode.

The method may further include analyzing the image of the document and detecting the error generated due to the shape of the bound document, after the bound document is scanned, and correcting the detected error in a predetermined correction mode.

In order to detect the error, a size area of the scanned image of the document may be detected, page areas of the image of the document may be detected, a boundary area of the image of the document may be detected, a central portion of the image of the document may be detected, and a shadow area of the central portion of the image of the document may be detected.

The scanned image of the document may be stored after the bound document is scanned.

When the image of the document is displayed, a change message relating to whether the correction mode is changed may be further displayed, and a selection message to select the correction mode may be further displayed together with the change message.

The user may be allowed to input change selection information.

The foregoing and/or other aspects and utilities of the general inventive concept may also be achieved by providing an image reading apparatus including a control unit to control error correction in a scanned image of a document, wherein the error correction corresponds to detecting and dividing the document into a plurality of page areas on a basis of a central portion thereof.

The error may be corrected in a correction mode by a user input.

The foregoing and/or other aspects and utilities of the general inventive concept may also be achieved by providing an image reading apparatus including a control unit to control an correction of an error generated in a scanned image of a document by detecting and dividing the document into a plurality of page areas on a basis of a central portion thereof, and a displaying unit to display and to allow a user to select change selection information corresponding to the error correction of the control unit.

The foregoing and/or other aspects and utilities of the general inventive concept may also be achieved by providing a method of correcting an image using an image reading apparatus, the method including controlling error correction in a scanned image of a document by detecting and dividing the document into a plurality of page areas on a basis of a central portion thereof, and displaying change selection information corresponding to the error correction of the control unit.

The foregoing and/or other aspects and utilities of the general inventive concept may also be achieved by providing the method of may further include allowing a user to select the change selection information, and correcting the error based on the selection by the user.

The foregoing and/or other aspects and utilities of the general inventive concept may also be achieved by providing a computer-readable recording medium having embodied thereon a computer program to execute a method, wherein the method includes controlling error correction in a scanned image of a document by detecting and dividing the document into a plurality of page areas on a basis of a central portion thereof, and displaying change selection information corresponding to the error correction of the control unit.

As described above, according to the image reading apparatus and the method of forming the image using the same of the present general inventive concept, since an error generated due to a shape of a bound document can be corrected according to a selection of the user, satisfying a variety of user's desires is possible and providing convenience to the user.

In addition, preventing an unexpected resultant from being output is possible.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating an image of a document read using a conventional image reading apparatus;

FIG. 2 is a view illustrating an image of a document corrected in a predetermined correction mode using the conventional image reading apparatus;

FIG. 3 is a block diagram illustrating an image reading apparatus according to an embodiment of the present general inventive concept;

FIG. 4 is a view illustrating an image of a document, a change message and a selection message displayed on a display unit illustrated in FIG. 3; and

FIG. 5 is a flowchart illustrating a method of correcting an image using the image reading apparatus according to an embodiment of the present general inventive concept.

### DETAILED DESCRIPTION OF THE PREFERRED EMBODIMENTS

Reference will now be made in detail to embodiments of the present general inventive concept examples of which are illustrated in the accompanying drawings, wherein like reference numerals refer to the like elements throughout. The embodiments are described below to explain the present general inventive concept by referring to the figures.

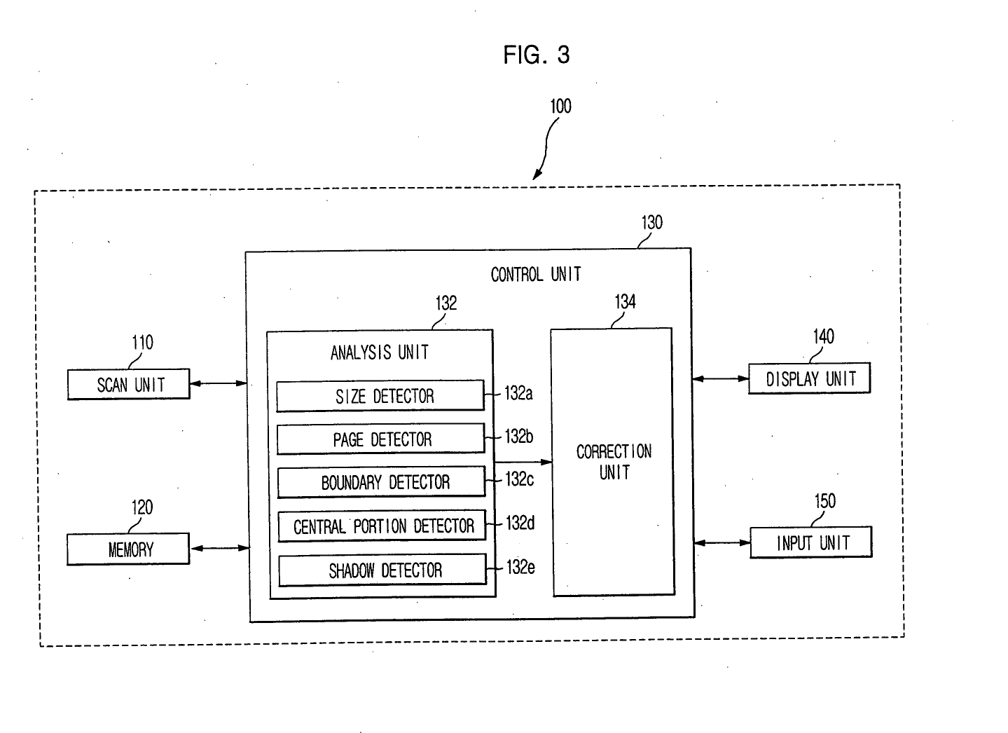

As illustrated in FIG. 3, an image reading apparatus 100 according to an embodiment of the present general inventive concept includes a scan unit 110, a memory 120, a control unit 130, a display unit 140 and an input unit 150.

The scan unit 110 scans a bound document and includes an image sensor to read an object to be read, such as a book to be read (or a bound document). The image sensor irradiates light onto a document placed on a reading plane and reads the document. A flat-bed scanning type image reading apparatus further includes a transporting device to transport the image sensor. A bound document may include, for example, a document having two or more pages that are joined such as by a spine.

The memory 120 includes a non-volatile memory such as a read only memory (ROM) to store a variety of control programs necessary to implement functions of the image reading apparatus 100 and a volatile memory such as a dynamic random access memory (DRAM) to store an image of a document scanned by the scan unit 110 and a correction mode to correct an error generated in the image of the document due to the shape of the bound document.

The control unit 130 includes an analysis unit 132 to detect the error generated in the image of the document stored in the memory 120 due to a shape of the bound document and a correction unit 134 to correct the detected error in a predetermined correction mode.

Here, the analysis unit 132 includes a size detector 132a, a page detector 132b, a boundary detector 132c, a central portion detector 132d and a shadow detector 132e, in order to detect the error generated due to the shape of the bound document, that is, a curved central portion of the bound document. The error may be, for example, an inaccuracy of a scanned-version of the image.

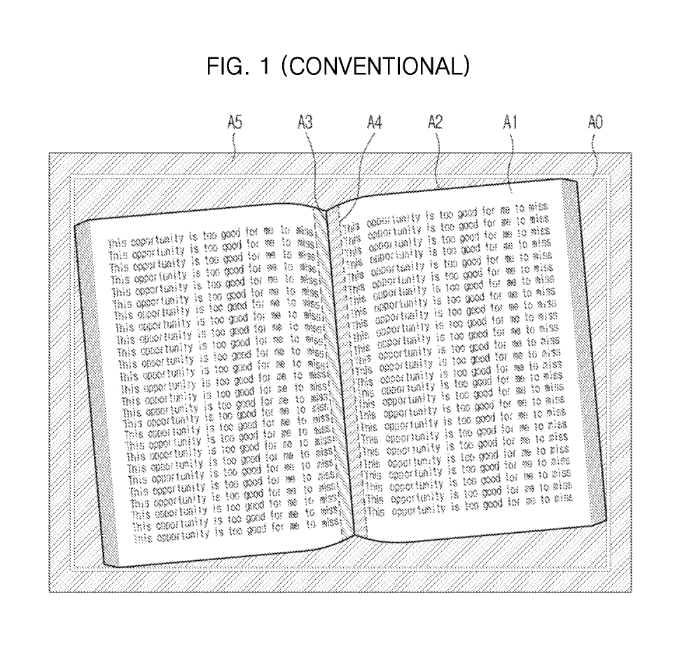

As illustrated in FIG. 1, the size detector 132a detects a rectangular minimum size area A0 including an image area of a document from the scanned image.

The page detector 132b detects page areas A1 of the image of the document. Since the page areas are symmetrically formed in a general document, an overall page area of the scanned document is detected and is divided into the page areas on a basis of the central portion of the detected area.

The boundary detector 132c detects a boundary area A2 of the image of the document. The boundary area A2 may be, for example, a perimeter area not including an image therein surrounding respective pages of the bound document. Skew angles of left and right pages can be detected using the detected boundary area.

The central portion detector 132d detects the central portion A3, that is, a folded portion between the left and right pages of the document.

The shadow detector 132e detects a shadow area A4 which is generated in the central portion A3 of the image of the document. The shadow area A4 may include, for example, an area of or proximate to the central portion A3 having a shadow in the scanned-version due to an image sensor not detecting the shadow area A3.

In more detail, since a binding portion of the scanned document becomes spaced apart from the scan unit 110 according to a binding state of the document to generate the shadow area, the shadow detector 132e detects the shadow area.

The correction unit 134 corrects the error detected by the analysis unit 132 in the predetermined correction mode.

The correction mode is a mode to correct the error of the read document and includes an output correction mode to divide a document into two pages, that is, the left and right pages, and output the divided pages, a straight-line correction mode to correct a curved portion of the central portion of the document to an original state, a removal correction mode to remove the black shadow area of the central portion of the document, and a cut correction mode to cut the image of the document. In addition to the above-described correction modes, a variety of correction modes may be used.

Hereinafter, an operation of the correction unit 134 will be described. If the image of the document is previously set to be corrected in the removal correction mode and the cut correction mode, the correction unit 140 determines in which range the shadow area exists using the shadow area detected by the shadow detector 132e, performs the removal correction mode to remove the shadow area of the central portion of the document, and performs the cut correction mode to cut the image of the document using the boundary area detected by the boundary detector 132c.

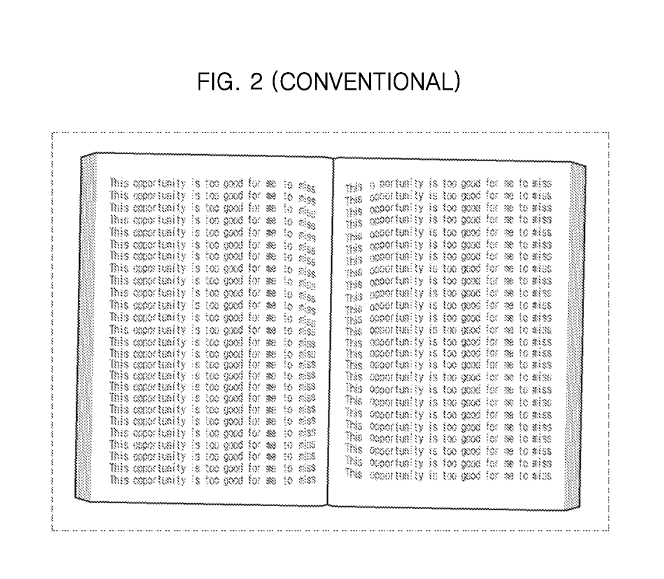

However, if the image of the document is corrected in the predetermined correction mode, as illustrated in FIG. 2, the shadow area of the central portion of the document is removed and the image of the document is cut, but the curved portion of the central portion of the document is not corrected, the image of the document cannot be easily checked.

Accordingly, the correction unit 134 corrects the error in a correction mode input by a user.

For example, if the straight-line correction mode, the removal correction mode and the cut correction mode are input through the input unit 160, the correction unit 134 performs the straight-line correction mode, the removal correction mode and the cut correction mode.

The display unit 140 displays the corrected image of the document on a predetermined screen display device.

Here, the predetermined screen display device may be, for example, a device to display the image of the document, such as a liquid crystal display (LCD) device, a plasma display panel (PDP) device, a TFT-LCD device, an organic electroluminescence display (OLED) device, and a cathode ray tube (CRT) device. The image reading apparatus 100 according to the present embodiment is connected to a user terminal such as a computer, which supports data communication, such that the image of the document is displayed on the screen display device of the user terminal.

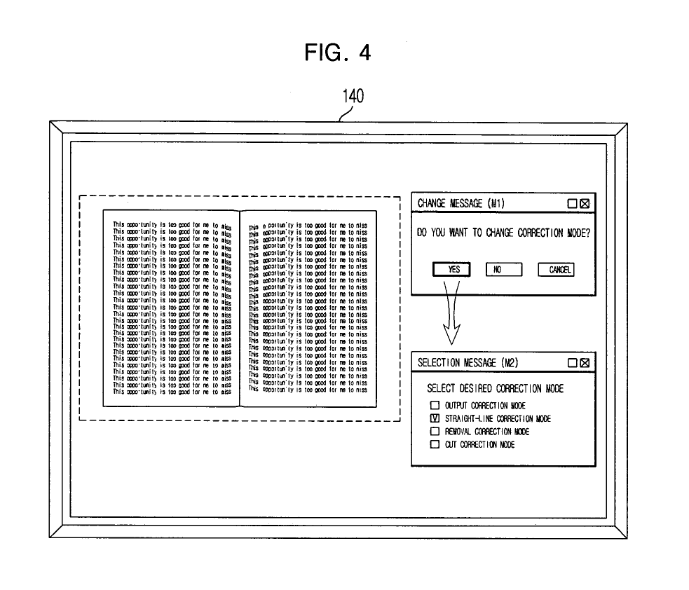

Referring to FIGS. 3 and 4, the display unit 140 further displays a change message relating to whether a correction mode is changed, in addition to the image of the document. Accordingly, the user changes the correction mode.

If the user wants to change the correction mode, the display unit 140 further displays a selection message to select the correction mode.

For example, the display unit 140 displays the change message “Do you want to change the correction mode?”. If the user selects “Yes”, the selection message “Select a desired correction mode” is displayed such that the user is allowed to select the desired correction mode.

The image reading apparatus 100 displays the image of the document and corrects the error is corrected in the predetermined correction mode. The image reading apparatus 100 displays the image on the predetermined screen display device and allows the user to check the displayed image of the document and to change the correction mode, such that the user's desire can be satisfied.

The input unit 150 allows the user to input change selection information and the correction mode.

That is, if the change message is displayed on the display unit 140, the input unit 150 receives the change selection information input by the user. If the input change selection information indicates the change of the correction mode, the input unit 150 further receives the correction mode. The input unit 150 includes an operation panel, which includes a plurality of function buttons and numerical buttons to set a variety of functions of the image reading apparatus 100.

The input unit 150 allows the user to input the correction mode in order to correct the error generated in the scanned image of the document due to the shape of the bound document.

That is, when the bound document is scanned, the user inputs the correction mode through the operation panel provided in the image reading apparatus 100 such that the error can be corrected in the input correction mode.

The display unit 140 displays the scanned image of the document such that the user checks the error of the image, and the input unit 150 allows the respective user to select and/or input the correction mode. Since the user checks the scanned image of the document, finds the error of the image, and inputs the correction mode corresponding to the selection of the user, correcting the error according to the user's desire is possible.

Hereinafter, a method of correcting the image using the image reading apparatus according to an embodiment of the present general inventive concept will be described.

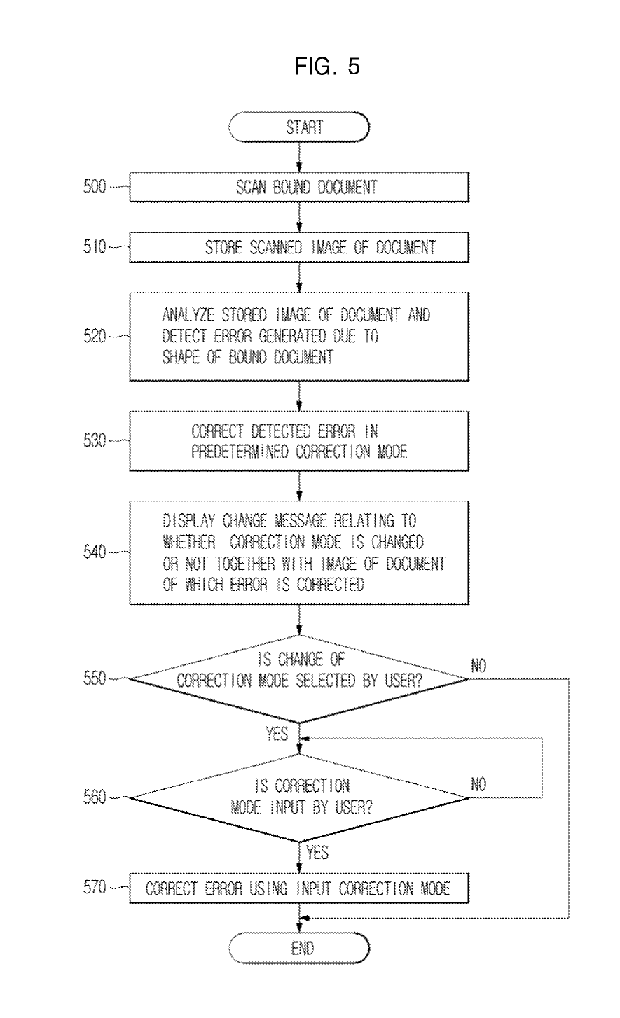

FIG. 5 is a flowchart illustrating the method of correcting the image using the image reading apparatus according to an embodiment of the present general inventive concept.

Referring to FIGS. 3 and 5, the bound document is scanned by the scan unit 110 (operation 500) and the scanned image of the document is temporarily stored in the memory 120 (operation 510).

The control unit 130 analyzes the image of the document stored in the memory 120, detects the error generated due to the shape of the bound document (operation 520), and corrects the detected error in the predetermined correction mode (operation 530).

The control unit 130 detects the rectangular minimum size area including the scanned image of the document, detects the page areas of the image of the document, detects the boundary area of the image of the document, detects the central portion of the image of the document, and detects the shadow area of the central portion of the image of the document, in order to detect the error.

After the detected error is corrected in the predetermined correction mode, the display unit 140 displays the change message relating to whether the correction mode is changed on the screen display device, together with the corrected image of the document (operation 540).

A determination is made whether the change of the correction mode is selected by the user (operation 550). If the change of the correction mode is selected, then a determination is made whether the correction mode is input by the user (560). If a determination is made that the correction mode is input, the error is corrected using the input correction mode (operation 570).

For example, if the correction mode input by the user is information on the output correction mode, the removal correction mode and the cut correction mode, the control unit 130 corrects the error in the output correction mode, the removal correction mode and the cut correction mode using the input correction mode.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An image reading apparatus, comprising:
a control unit to correct an error generated in a scanned image of a bound document due to a shape of the bound document; and
a display unit to display the image of the document of which the error is corrected,
wherein the control unit corrects the error in a correction mode input by a user.

2. An image reading apparatus, comprising:
an input unit to allow a user to input a correction mode in order to correct an error generated in a scanned image of a bound document due to a shape of the bound document; and
a control unit to correct the error in the input correction mode.

3. The image reading apparatus according to claim 2, further comprising:
a display unit to display the scanned image of the document.

4. The image reading apparatus according to claim 1, wherein the control unit includes:
an analysis unit to analyze the image of the document and detect the error generated due to a shape of the bound document; and
a correction unit to correct the detected error in a predetermined correction mode.

5. The image reading apparatus according to claim 4, wherein the analysis unit includes a size detector to detect a size area of the scanned image of the document.

6. The image reading apparatus according to claim 4, wherein the analysis unit includes a page detector to detect page areas of the image of the document.

7. The image reading apparatus according to claim 4, wherein the analysis unit includes a boundary detector to detect a boundary area of the image of the document.

8. The image reading apparatus according to claim 4, wherein the analysis unit includes a central portion detector to detect a central portion of the image of the document.

9. The image reading apparatus according to claim 4, wherein the analysis unit includes a shadow detector to detect a shadow area of a central portion of the image of the document.

10. The image reading apparatus according to claim 1, further comprising:
a memory to store the scanned image of the document.

11. The image reading apparatus according to claim 1, wherein the display unit further displays a selection message to select the correction mode.

12. The image reading apparatus according to claim 11, further comprising:
an input unit to allow the user to input the correction mode.

13. The image reading apparatus according to claim 11, wherein the display unit further outputs a change message relating to whether the correction mode is changed.

14. The image reading apparatus according to claim 12, wherein the input unit allows the user to input change selection information.

15. The image reading apparatus according to 1, wherein the correction mode includes an output correction mode to divide the document into pages and output the pages of the document, a straight-line correction mode to correct a curved portion of a central portion of the document to an original state, a removal correction mode to remove a shadow area of the central portion of the document, and a cut correction mode to cut the image of the document.

16. A method of correcting an image using an image reading apparatus, the method comprising:
scanning a bound document;
correcting an error generated in an image of the document due to a shape of the bound document;
displaying the image of the document on a predetermined screen display device;
allowing a user to input a correction mode; and
correcting the error in the input correction mode.

17. The method according to claim 16, further comprising:
analyzing the image of the document and detecting the error generated due to the shape of the bound document, after the bound document is scanned; and
correcting the detected error in a predetermined correction mode.

18. The method according to claim 17, wherein, in order to detect the error, a size area of the scanned image of the document is detected;
page areas of the image of the document are detected;
a boundary area of the image of the document is detected;
a central portion of the image of the document is detected; and
a shadow area of the central portion of the image of the document is detected.

19. The method according to claim 16, wherein the scanned image of the document is stored after the bound document is scanned.

20. The method according to claim 16, wherein, when the image of the document is displayed, a change message relating to whether the correction mode is changed is further displayed.

21. The method according to claim 20, wherein a selection message to select the correction mode is displayed together with the change message.

22. The method according to claim 20, wherein the user is allowed to input change selection information.

23. An image reading apparatus, comprising:
a control unit to control error correction in a scanned image of a document,
wherein the error correction corresponds to detecting and dividing the document into a plurality of page areas on a basis of a central portion thereof.

24. The apparatus of claim 23, wherein the error is corrected in a correction mode by a user input.

25. An image reading apparatus, comprising:
a control unit to control an correction of an error generated in a scanned image of a document by detecting and dividing the document into a plurality of page areas on a basis of a central portion thereof; and
a displaying unit to display and to allow a user to select change selection information corresponding to the error correction of the control unit.

26. A method of correcting an image using an image reading apparatus, the method comprising:
controlling error correction in a scanned image of a document by detecting and dividing the document into a plurality of page areas on a basis of a central portion thereof; and
displaying change selection information corresponding to the error correction of the control unit.

27. The method of claim 26, further comprising:
allowing a user to select the change selection information; and
correcting the error based on the selection by the user.

28. A computer-readable recording medium having embodied thereon a computer program to execute a method, wherein the method comprises:
controlling error correction in a scanned image of a document by detecting and dividing the document into a plurality of page areas on a basis of a central portion thereof; and
displaying change selection information corresponding to the error correction of the control unit.
